(19) United States
(12) Patent Application Publication
(10) Pub. No.: US 2024/0130559 A1
(43) Pub. Date: Apr. 25, 2024

(54) DRINKING RECIPIENTS WITH ENHANCED FLOW REGULATION MEANS, SYSTEMS AND PROCESSES WITH SAID DRINKING RECIPIENTS

(71) Applicant: NOVADELTA-COMÉRCIO E INDÙSTRIA DE CAFÉS, LDA, Lisboa (PT)

(72) Inventors: Rui Miguel NABEIRO, Campo Maior (PT); Jesùs MEDINA MUNDT, Lisboa (PT)

(73) Assignee: NOVADELTA-COMÉRCIO E INDÙSTRIA DE CAFÉS, LDA, Lisboa (PT)

(21) Appl. No.: 17/768,710

(22) PCT Filed: Oct. 27, 2020
(86) PCT No.: PCT/PT2020/050039

§ 371 Date: Apr. 12, 2022

(30) Foreign Application Priority Data
Oct. 30, 2019 (PT) 115874

(51) Int. Cl. A47J 31/46; A47J 31/52

(52) U.S. Cl. CPC A47J 31/461; A47J 31/52

(57) ABSTRACT

Drinking recipients such as for example glasses, cups and similar, that present flow regulation mechanisms at a base region and are adapted to provide better retention, use longevity and reliability, and better regulation of the flow passage there through, at least for flow pressures of up to 20 bar, and simultaneously provide liquid sealing relative to an injection device upstream thereof. Systems and processes for distributing beverages, in particular of espresso coffee and similar aromatic beverages, having at least one type of the drinking recipient, and an apparatus having a beverage discharge disposition adapted for operative retention of the drinking recipient and for beverage discharge in a pressurized flow through the base region, at least for flow pressures of up to 20 bar.

### FIELD OF THE INVENTION

The present invention refers to the field of the drinking recipients, in particular for aromatic beverages, whereby the beverage discharge into the recipient takes place in a direction opposite to the direction of the gravity force, and to systems and process for preparing beverages based upon the use of said drinking recipients.

### BACKGROUND OF THE INVENTION

The prior art presents several solutions of apparatus with beverage discharge in a direction opposite to the direction of the gravity force. In particular, in the case of beverage preparation systems based upon an individual portion of precursor substance, such as for example a capsule or a pod containing roasted ground coffee beans, or other edible substance, in each preparation cycle there is an introduction of said individual portion in a beverage preparation device and posterior ejection thereof out of such device after beverage preparation and discharge. Said beverage preparation device can be automatically actuated, for example by means of an electric motor, between open and closed position, and thereby collect and eject said individual portion.

The document DE 10 2009 048233 A1 discloses a drinking recipient adapted so that can collect a pressurized beverage flow through a base region thereof, presenting a blocking element provided so that it is tensioned up in a closed position, in particular by an elastic string, and can be displaced to an open position where it provides flow passage to the drinking recipient.

The document US 2008/0223478 A1 discloses a drinking recipient with flow regulation means such as a duckbill valve, an umbrella valve, or a permeable membrane, and that can be retained by means of pressured-fitting in a retention opening provided on the base wall of said recipient.

The document WO 2016/071880 A1 discloses another drinking recipient of the type of the present invention that presents a valve in the base region thereof comprising a deformable element that is mounted under pressure in a sealing position to liquid-leaks, and can be deformed in the filling position when the flow pressure reaches a previously determined compression value of said deformable element.

The document WO 2017/200409 A1 filed by the author of the present invention, relates to a beverage preparation system of the type of the present invention, comprising drinking recipients adapted so that can be operatively retained in the beverage discharge disposition of beverage preparation apparatuses. In particular, this document discloses more ergonomic solutions of general configuration of the apparatus and communication interfaces thereof. Moreover, the document further discloses a process for preparing a beverage that includes the detection of operative state of the flow pressurization device, as well as the placement and correct placement of the drinking recipient on the beverage discharge disposition, whereby said flow pressurization device is prevented from operating as long as there detected the non-placement or the incorrect placement of the drinking recipient on the beverage discharge. This measure of operation control advantageously provides more reliability and safety of use of a system of this type. Said process further includes the display of information of operational state relating to the correct placement of the drinking recipient.

The document WO 2018/194475 A1 also filed by the author of the present invention, is also related to a beverage preparation system of the type of the present invention. In particular, this document discloses a drinking recipient with means and dispositions for optimizing the flow passage through a portion of the base region of said drinking recipient, to the collection space thereof.

The document WO 2019/078748 A1 also filed by the author of the present invention, discloses a drinking recipient that presents flow regulation means of umbrella valve type retained on a base wall thereof.

None of the documents in the prior art discloses a solution that provides a drinking recipient with enhanced flow regulation means, in particular of simple construction and reliable and effective performance.

### General Description of the Invention

The objective of the present invention is to provide drinking recipients, such as for example glasses, cups and similar items, presenting flow regulation means in a base region thereof, adapted and arranged so that provide better regulation of flow passage, and so that simultaneously provide a reliable liquid sealing relative to pressurized beverage injection means upstream thereof.

Said flow regulation means can be of the single-way valve type, including umbrella valve, duckbill valve, and similar.

In particular, the objective of the present invention is to provide flow regulation means that are simple and efficient.

This objective is attained according to the present invention by means of a drinking recipient according to claim 1, whereby preferred embodiments are presented in the depending claims.

In particular, this objective is solved according to the present invention by means of drinking recipients that present flow regulation means provided as a single piece, preferentially in a synthetic material with elastic behaviour.

The objective can be solved by means of drinking recipients that comprise flow regulation means that can present an upstream portion and a downstream portion that confine a common flow passage along the prevailing flow direction, whereby the upstream portion presents an exterior transversal section with a characteristic dimension, for example exterior diameter, that is bigger than the exterior transversal section of the downstream portion and configured so that can sit on an upstream-oriented surface of the base opening, and whereby the downstream portion is configured so that can be retained by means of pressured fitting inside of the base opening and comprises a flow regulation wall adapted so that provides a flow passageway in case of being impinged with an upstream flow pressure bigger than a previously defined value of flow pressure.

In particular, the flow regulation wall is configured so that confines a flow passageway at least externally relative to a centre thereof, and that can be elastically actuated so as to provide said flow passageway in case of being impinged with an upstream flow pressure that is bigger than a previously defined value of flow pressure.

In particular, the flow regulation wall confines a slot-like flow passageway that can be elastically actuated by the upstream flow pressure between a substantially closed position and open position.

The flow regulation means can confine a space of tubular section upstream of flow regulation wall that presents at least one slot-like opening for flow passage adapted so that can be opened in at least partially elastic manner, preferentially in elastic manner, in case of being impinged with an upstream flow pressure that is bigger than a previously defined value of flow pressure, whereby said flow passageway presents a characteristic dimension, in particular extension between edges, comprised between 1 and 10 mm, preferentially between 1.5 and 5 mm.

Said flow regulation wall can extend with a semi-sphere or a part of sphere-like shape, with the concavity oriented upstream, and said flow passageway can be configured so that extends along a single linear extension and adapted so that can be opened in at least partially elastic manner, preferentially in elastic manner, when said flow regulation wall is impinged with an upstream flow pressure that is bigger than a previously defined value of flow pressure.

The flow regulation means can comprise a flow regulation wall that confines a space of tubular section upstream of a flow passageway associated with the perimeter of the downstream free edge of the downstream portion, the flow regulation wall being preferentially retained on the inner side by means of form fitting on a portion of the base wall of the drinking recipient, and the flow passageway being adapted so that can be opened in the case of being impinged with an upstream flow pressure that is bigger than a previously defined value of flow pressure.

Said flow regulation wall can extend in tubular shape with an interior side confining the flow upstream of the flow passageway, and adapted so that can be opened in at least partially elastic manner, preferentially in elastic manner, in case the downstream free edge of said flow regulation wall is impinged with an upstream flow pressure that is bigger than a previously defined value of flow pressure.

It is preferred when said flow pressure for opening the flow passageway is bigger than 1,5 bar, preferentially bigger than 1,8 bar, and smaller than 20 bar, preferentially smaller than 18 bar.

Another objective of the present invention is to provide a drinking recipient with a single-way valve that provides a greater number of uses, before entering into material fatigue, or relaxing the elastic behaviour associated with respective flow passageway.

This objective is solved according to the present invention by means of a drinking recipient with flow regulation means, of single-way valve type, whereby an upstream portion presents a material surface that extends transversally, for example in rim-like manner, relative to a flow passage section laterally surrounded by an elastic sidewall. Said material extension advantageously presents a characteristic dimension, for example a diameter, that corresponds to at least twice the characteristic dimension of the flow passage section, for example the diameter thereof.

Said material surface is adapted so that can be impinged, including compressed, by the beverage discharge means when the drinking recipient is placed in operative position in a beverage discharge disposition of an apparatus, thereby providing the only liquid sealing of the drinking recipient with the beverage discharge means.

A related objective of the present invention is to provide a drinking recipient whereby it is easier to place said flow regulation means in a respective retention seat, retain them thereon in reliable manner and easily replacing them, in particular manually without requiring the use of a tool for such purpose.

In particular, this objective is solved by a drinking recipient with flow regulation means adapted so that can be retained by means of pressured-fitting in a retention portion of the base wall of the drinking recipient, and are thereby additionally retained by a seating portion associated with said retention portion of the base wall.

Another objective of the present invention is to disclose a beverage preparation system including a beverage preparation apparatus providing more efficient and ergonomic operation, including for discharge of different types of beverages.

This objective is solved according to claim 14.

In particular, this objective is attained with a drinking recipient according to any of claims 1 to 13.

In particular, the system can include at least two types of drinking recipients that present at least one of: different format and different configuration of the base wall, and that can further include at least two types of flow regulation means that presents at least one: flow regulation wall of different format and flow passageway of different dimension.

The system can further include an individual portion of edible substance, eventually including a package for collection thereof, for example of the type capsule, pod, edible coating or similar, and said apparatus can comprise at least one beverage preparation device, in particular for brewing aromatic beverages, such as for example espresso type coffee, adapted so that be driven by an actuation device, such as for example an electric motor, and thereby collect said individual portion of edible substance, and a beverage discharge disposition adapted so that can discharge in a direction opposite to the direction of the gravity force.

The apparatus can further present control means adapted so as to provide a simpler and more ergonomic operation of the apparatus in general, and of each beverage preparation cycle in particular.

Another objective of the present invention is to provide a simpler and more efficient process of production of a drinking recipient that includes flow regulation means in the base region.

This objective is solved by means of a process according to claim 15.

In particular, the objective can be solved by means of a process that includes the production of a drinking recipient according to any of claims 1 to 13.

### DESCRIPTION OF THE FIGURES

The invention shall be hereinafter explained in greater detail based upon preferred embodiments and the attached Figures.

The Figures show, in simplified schematic representations:

FIG. 1: side and top view of a first embodiment of drinking recipient (1) and beverage preparation apparatus (10) in a system according to the present invention;

FIG. 2: side and top view of a drinking recipient (1) placed on a beverage discharge disposition (2) of apparatus (10) of a system according to the present invention;

FIG. 3: side and top view of embodiment of drinking recipient (1) according to the present invention;

FIG. 4: side-cut view of a first type of drinking recipient (1) according to the present invention;

FIG. 5: detail view of drinking recipient (1) according to FIG. 4;

FIG. 6: side-cut view of a first embodiment of flow regulation means (13) according to FIG. 4;

FIG. 7: side-cut view of a second embodiment of flow regulation means (13) according to FIG. 4;

FIG. 8: side-cut view of a third embodiment of flow regulation means (13) according to FIG. 4;

FIG. 9: side and top views of an embodiment of flow regulation means (13) according to FIG. 4;

FIG. 10: side-cut view of an embodiment of flow regulation means (13) according to FIG. 4;

FIG. 11: side-cut view of a second type of drinking recipient (1) according to the present invention;

FIG. 12: detail view of the embodiment of drinking recipient (1) according to FIG. 11;

FIG. 13: side-cut view of a first embodiment of flow regulation means (13) according to FIG. 11;

FIG. 14: side-cut view of a second embodiment of flow regulation means (13) according to FIG. 11;

FIG. 15: side and top views of an embodiment of flow regulation means (13) according to FIG. 11;

FIG. 16: side-cut view of an embodiment of flow regulation means (13) according to FIG. 11.

### DETAILED DESCRIPTION OF PREFERRED EMBODIMENTS OF THE INVENTION

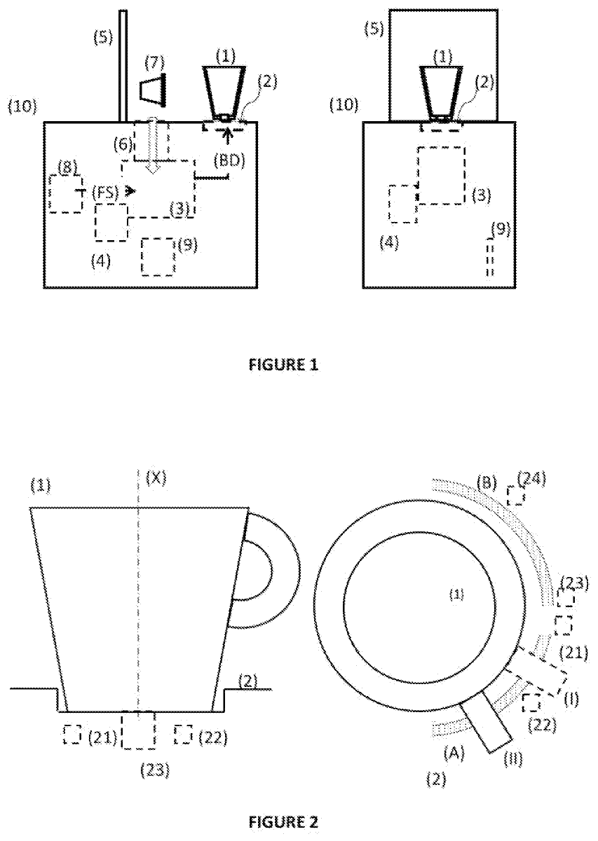

FIG. 1 represents side (on the left-hand side of the drawing) and frontal views of an embodiment of beverage preparation system according to the present invention that includes a drinking recipient (1), an individual portion (7) of a beverage precursor substance, for example in the form of a capsule such as referenced in the drawings, or similar, and a beverage preparation apparatus (10).

Said apparatus (10) can include a fluid reservoir (not represented), as well as fluid heating means, for example a thermoblock (not represented), and a flow pressurization device (8), for example a hydraulic pump, so that can provide a fluid supply (FS) at a temperature comprised between 60 and 100° C. and at a pressure comprised between 1 and 20 bar, preferentially between 8 and 16 bar, so as to interact with said edible substance. These means are known to the expert in the field so that one abdicates from a more detailed representation or description thereof.

Moreover, said apparatus (10) presents a beverage preparation device (3), referred to in the drawings as extraction device, provided so that can collect said individual portion (7), and impinge the latter with the pressurized flow (FS) so that mixes with the edible substance and results in a beverage. Said beverage preparation device (3) can be driven between open and closed positions, and vice-versa, by means of an actuation device (4), such as for example an electric motor. The individual portion (7) can be supplied to the beverage preparation device (3) by insertion into a respective portion inlet (6). An access disposition (5) configured as actionable lid-like element, can enable access to the portion inlet (6). Other possibilities of supply individual portions (7) are not excluded from the scope of the present invention. Operation of the apparatus (10), including of the flow pressurization (8) and beverage preparation device (3), can be regulated by control means (9).

After preparing the beverage, the flow beverage (BD) is conducted from an exit of the extraction device (3) to a beverage discharge disposition (2) arranged downstream thereof so that the beverage discharge to the interior of said drinking do drinking recipient (1) takes place through the base region thereof.

In the case of this preferred embodiment, the apparatus (10) further presents an access disposition (5) adapted so that can be moved between a first and a second position where it provides access to the beverage discharge disposition (2) for placement of the drinking recipient (1), and vice-versa.

Said apparatus (10) further comprises control means (9) adapted so that can control the operation of several components of the apparatus (10), including of said actuation device (4), and the display of information to a user.

FIG. 2 diagrammatically represents the placement of drinking recipient (1) on a beverage discharge disposition (2). In particular, the drinking recipient (1) can be placed by the user in a first retention position, associated with a previously defined handling alignment (A), where along it is correctly retained, and hereinafter be manipulated by the user along said handling alignment (A), thereby actuating a first and a second recipient sensor (21, 22).

It is preferred when the drinking recipient (1) can be retained by means of rotation by a first angular extension around its longitudinal central axis (X), and then be manipulated in further angular extensions of the rotation movement, in either direction, along the handling alignment (A).

It is preferred when the first recipient sensor (21) is associated with a position of retention of the drinking recipient (1) on the beverage discharge disposition (2).

It is preferred when the second recipient sensor (22) is associated with a previously defined extension of said handling alignment (A) whose relative dimension can be associated in each cycle by the control means (9) to a corresponding quantity of beverage to be discharged.

It is preferred when said handling alignment (A) extends around the exterior perimeter of the drinking recipient (1) placed on the beverage discharge disposition (2), in particular so that the second recipient sensor (22) can be actuated by the further rotation of the drinking recipient (1) around a central longitudinal axis (X), between a first (I) and a second position (II).

The beverage discharge disposition (2) can present a second handling alignment (B), for example associated with a different type of beverage discharge, or to a second type of beverage, such as for example tea. A third recipient sensor (24) is in this case further associated with said second handling alignment (B).

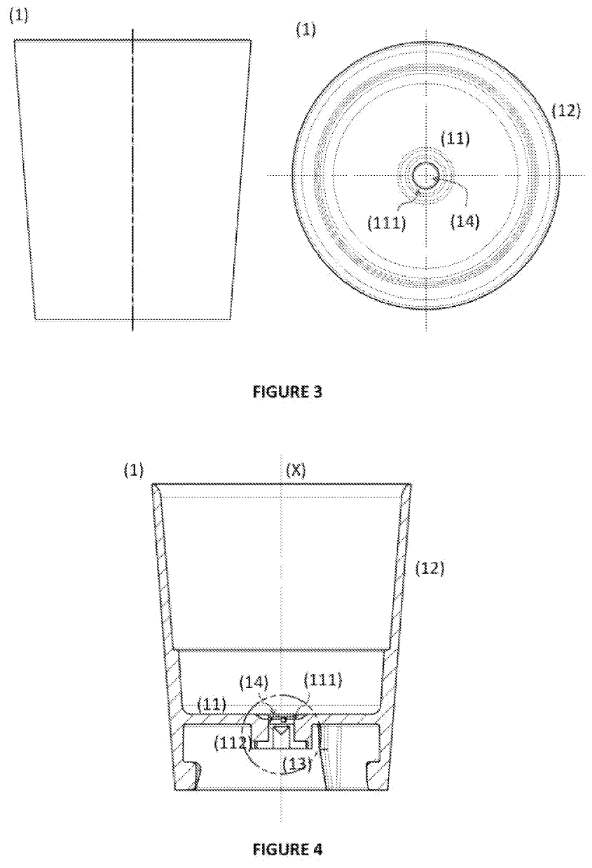

A drinking recipient (1) according to the present invention is represented in FIG. 3, presenting a base wall (11) and a sidewall (12) confining a collection space for a beverage volume and configuring a drinking opening.

The drinking recipient (1) presents a base opening no the base wall (11) that can further present a flow obstacle wall (14) configured so as to provide a deflection of the beverage flow at the entry region of the collection space, so that the beverage flows along a generally non vertical direction. These elements are known from prior art so that one herewith abdicates form a description in greater detail thereof.

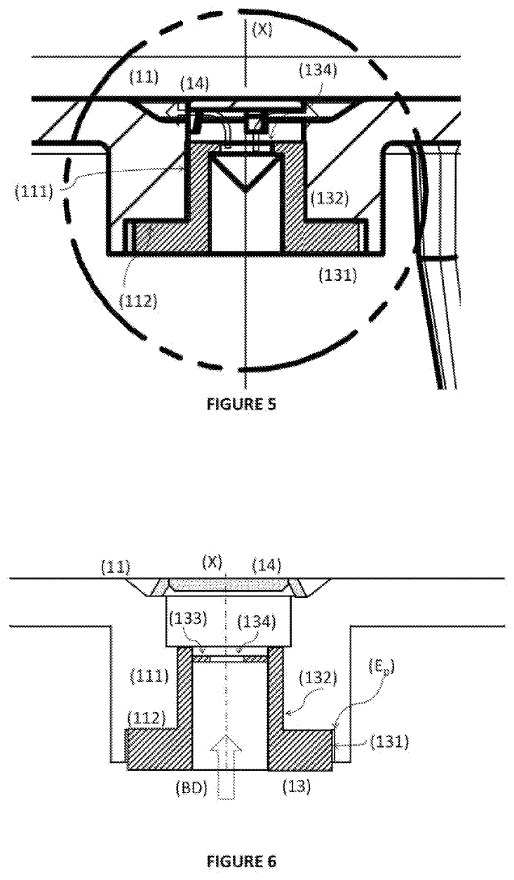

As can be better observed in FIGS. 4 and 5, the base wall (11) presents a base opening generally extending in the prevailing flow direction of beverage discharge (BD) and comprises flow regulation means (13), in particular of single-way valve type, adapted so that only provide flow passage in case of being impinged with an upstream flow pressure bigger than a previously defined value of flow pressure.

The base opening comprises a retention portion (111) que extends with tubular shape along a direction parallel to the prevailing flow direction, and a seating portion (112) that extends along a direction generally transversal relative to the prevailing flow direction.

In the case of the represented embodiments, the flow regulation means (13) are retained by means of pressurized fitting at least on said retention portion (111), preferentially also on said seating portion (112) of the base opening on the base wall (11).

In general, the flow regulation means (13) can present an upstream portion (131) that extends according to one of:
completely inside of the base wall (11), including at least in the most part of its extension along the prevailing flow direction, inside of said retention portion (111);
at least partially outside of the base wall (11), preferentially in a smaller part of its extension along the prevailing flow direction, adjacent to the upstream-oriented side thereof.

In general, the flow regulation means (13) further present a downstream portion (132) that extends completely inside of the base wall (11) and according to at least one of:
inside of the retention portion (111) at least along the most part of its extension along the prevailing flow direction;
at least partially outside of said retention portion (111), preferentially in a smaller part of its extension along the prevailing flow direction, adjacent to the downstream-oriented side thereof.

In general, the drinking recipient (1) can be adapted so that can be operatively placed on a beverage discharge disposition (2) functionally connected to a beverage preparation apparatus, in particular so that the drinking recipient (1) can be retained, preferentially by means of mechanical engagement of base region with the beverage discharge disposition (2).

Moreover, in general, the drinking recipient (1) can further present flow constraining means (14) associated with said base opening, preferentially at least partially inside of the base wall (11) and downstream of said retention portion (111) and from the flow regulation means (13), and configured so that the beverage flow can enter in the drinking recipient (1) along a non-vertical direction, or one different from the prevailing flow direction.

Said flow regulation means (13) can be provided as a single piece, produced by means of injection of a synthetic material, and arranged so that extend at least partially inside of said base opening.

According to an inventive aspect, the flow regulation means (13) can present only an upstream portion (131) with an exterior section adapted so that can be retained on the base opening of the base wall (11), or, alternatively, only an upstream portion (131) and a downstream portion (132) presenting an exterior section of different dimension and adapted so that can be both retained in the base opening of the base wall (11). In particular, said retention is provided so that at least most part of the exterior surface of said upstream and downstream portions (131, 132) can be pressure-fitted inside said base opening of the base wall (11).

Moreover, in the case of this embodiment, at least one of said upstream and downstream portions (131, 132) confines an interior flow section of tubular shape upstream of a flow regulation wall (133) that presents a flow passageway (134) extending in a generally transversal manner relative to the prevailing flow direction, and adapted so that can only be enlarged from a closed position to an open position, preferentially in elastic manner, in case of being impinged with an upstream flow pressure bigger than a previously defined value of flow pressure.

A simple e effective construction of said flow regulation means (13) is herewith provided.

It is preferred when the flow regulation means (13) are produced in a material that can be elastically deformed, such as for example FDA silicone.

FIGS. 6 to 8 represent details of the base wall (11) of drinking recipients (1) according to the present invention, presenting an upstream (131) and a downstream portion (132) with exterior sections of different characteristic dimension.

The upstream portion (131) presents a bigger characteristic dimension of the exterior transversal, for example diameter, than the downstream portion (132).

In all cases, the downstream portion (132) is provided with a characteristic dimension of the exterior transversal section at least approximately similar to the characteristic dimension of the interior transversal section of retention portion (111) of the base opening of the base wall (11), so that the downstream portion (132), and the flow regulation means (13), can be retained by means of pressured fitting on said retention portion (111) of the base opening of base wall (11).

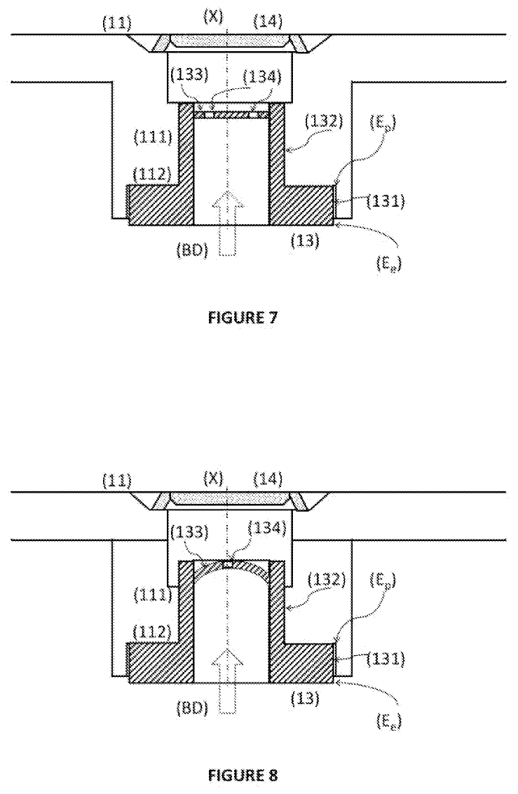

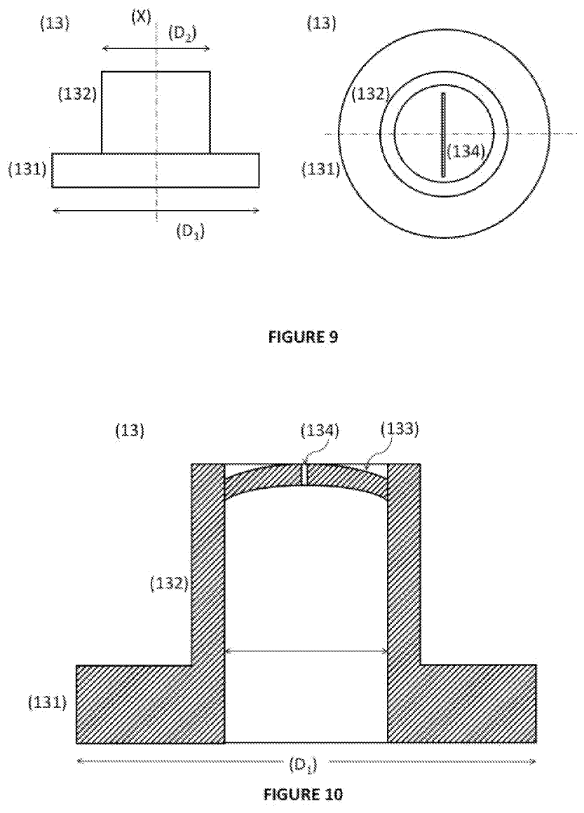

As represented, the flow regulation wall (133) can be provided inside of the tubular shape of the downstream portion (132) and extending generally along a direction different from the prevailing flow direction, preferentially at least in part transversal hereto, and can present one flow passageway (134), as in FIG. 6, or a plurality of flow passageways (134), as in FIG. 7. Moreover, the flow regulation wall (133) can present a sphere cap form, such as in FIG. 8.

In the case of these embodiments, said flow regulation means (13) are arranged on said seating portion (112) so that results a slot-like perimeter space (E r) associated with the upstream portion (131) and does not result a slot-like perimeter space associated with the downstream portion (132).

It is herewith advantageously provided the possibility of removing the flow regulation means (13) from the base opening, for example for the purpose of replacing them, while simultaneously ensuring liquid sealing thereof.

In fact, the drinking recipients (1) according to the present invention are provided so that the flow regulation means (13) can be manually replaced, without requiring the use of a tool for this purpose.

FIGS. 9 e 10 represent two embodiments of flow regulation means (13) in drinking recipients (1) according to the present invention.

The flow regulation means (13) present an upstream portion (131) and a downstream portion (132) of circular transversal section and confining an interior flow section also of circular form, and comprising a flow regulation wall (133) arranged in the proximity of the downstream edge of said downstream portion (132).

Said flow regulation wall (133) presents a wall thickness that is smaller than the wall thickness of said upstream and downstream portions (131, 132).

In particular, said flow regulation wall (133) is in this case provided with a general spherical cap-like form, in particular with the concavity oriented upstream.

The flow regulation wall (133) in this case presents a single flow passageway (134) of linear shape and that extends at least approximately through the geometric centre of said flow regulation wall (133).

Said flow regulation means (13) can present at least one, preferentially at least most part of the following dimensional relations:
maximum dimension along the prevailing flow direction smaller than 8 mm, preferentially smaller than 6 mm;
maximum dimension along the direction transversal to the prevailing flow direction smaller than 12 mm, preferentially smaller than 11 mm.

In particular, it has been shown as particularly advantageous when the characteristic dimension of the flow passage section, D_{F}, upstream of the flow regulation wall (133) is smaller than 5 mm, preferentially smaller than 4 mm, and bigger than 1 mm, preferentially bigger than 2 mm.

In particular, it has been further established as particularly advantageous when, in this type of flow regulation means (13), the characteristic dimension of the flow passageway (134) on the flow regulation wall (133) is smaller than 4 mm and bigger than 2 mm.

In fact, it has been shown that in this case better elastic behaviour can be obtained of opening and closing of said flow passageway (134), as well as more advantageous flow patterns there through, when said flow regulation wall (133) is impinged by an upstream hydraulic pressure bigger than 1,5 bar, preferentially bigger than 1,8 bar, and smaller than 20 bar, preferentially smaller than 18 bar.

A beverage preparation system according to the invention can comprise at least one of:
at least two types of drinking recipient (1, 1′) that present at least one of: different format and different configuration of the base wall (11);
at least two types of flow regulation means (13, 13′) that present at least one of: flow regulation wall (133, 133′) of different format and flow passageway (134, 134′) of different dimension.

It is preferred when the different types of drinking recipients (1, 1′) can be operatively placed on the same type of beverage preparation apparatus, in particular operatively retained on the same type of beverage discharge dispositions (2).

It is preferred when the different types of flow regulation means (13) can be used with different types of drinking recipients (1, 1′).

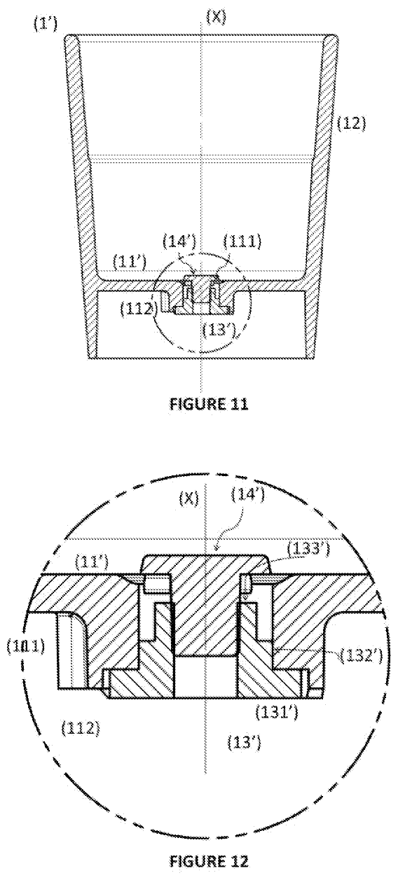

FIGS. 11 and 12 represent a second type of drinking recipient (1′) according to the present invention, with a base wall (11′) with a different configuration of the base wall (11) of the first type of drinking recipient (1) discussed above, and wherein there can be retained a second type of flow regulation means (13′) also different from those discussed above.

The drinking recipient (1′) further presents in this case a base opening that still presents a seating portion (112) arranged upstream and that provides a transversal seating surface for part of the flow regulation means (13), and a retention portion (111) arranged downstream and that provides an interior surface of tubular shape for retention of the flow regulation means (13). Moreover, the base wall (11) also presents flow constraining means (14) that can be provided as a single piece with the rest of the base wall (11) and that include a first flow deflecting portion that extends in a generally transversal extension relative to the prevailing flow direction upstream thereof.

But, in this case, the flow conditioning means (14) further include a retention portion that extends upstream along the prevailing flow direction, opposite hereto, and with a generally cylindrical or frusto-conic shape, and that can extend so as to engage with the flow regulation means (13′), for example along at least part, or the most part of said base opening, but preferentially does not extend outside thereof.

It is preferred when the flow conditioning means (14′) present a retention portion that extends so as to retaining engage with at least part of the downstream portion (132′), preferentially inside of the retention portion (111).

And, also in similar manner to the case of the previously discussed embodiment, the flow regulation means (13′) also in this case present a seating portion (131′) and a retention portion (132′).

Mas, in this case, the flow regulation means (13′) are configured with a retention portion (132′) of generally tubular shape and adapted so that can be retained by pressurized fitting inside of the retention portion (111) of the base wall, in particular in an upstream region thereof, and further additionally retained by form fitting inside the retention portion of the flow conditioning means (14′), in particular in a downstream region that includes the downstream edge of the retention portion (132′).

In this case, as should be promptly understood by the reader, the retention portion (132′) operates as flow regulation wall (133′), and the downstream edge thereof, adapted so that is elastically tensioned against the exterior wall of the retention portion of the flow constraining means (14′), can provide a flow passageway (134′) along the perimeter thereof when impinged by an upstream flow pressure bigger than a previously defined value of flow pressure.

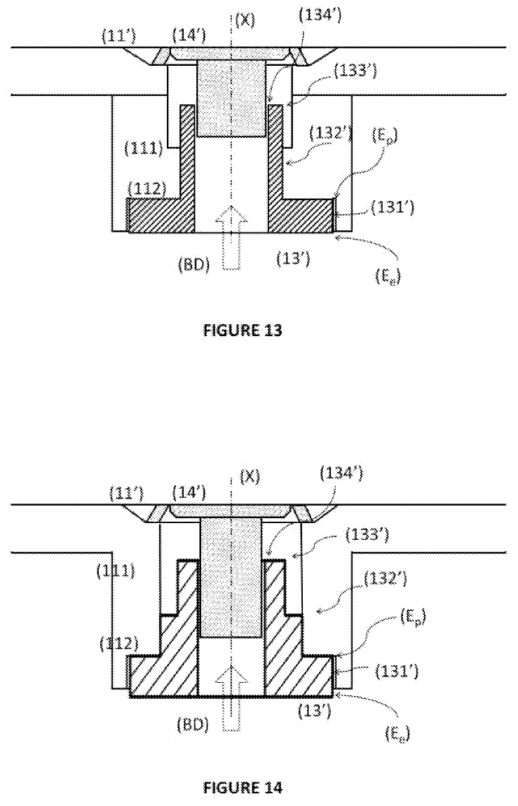

As can be derived from FIGS. 13 and 14, the flow regulation means (13′) can be retained from an upstream region of the base wall (11′), in particular so that an upstream portion (131′) sits in the seating portion (112) of the base opening and that a downstream portion (132′) can be pressure fitted inside the retention portion (111) of the base opening.

The flow of beverage discharge (BD) can be injected in the interior conduct confined by the upstream and downstream portions (131, 132′), and impinge the interface region between the downstream portion (132′) of the flow regulation means (13′) and the upstream portion of the flow conditioning means (14′), so that can elastically enlarge the downstream free edge of the downstream portion (132′), in this case corresponding to the flow regulation wall (133′), and thus provide the flow passageway (134′) along this perimeter region.

According to development tests carried out by the author, it has been demonstrated that a different downstream flow pattern can be obtained when the upstream portion of the flow conditioning means (14′) extends inside and along at least most part of the downstream portion (132′), as represented in FIG. 14.

Moreover, in the case of this embodiment, it has been demonstrated as advantageous when the downstream portion a (132′) of the flow regulation means (13′) presents two portions of different characteristic dimension of exterior transversal section, in the extension of the downstream portion (132′) along the prevailing flow direction, as also represented in FIG. 14.

In fact, it has been experimentally determined that the flow regulation behaviour through the flow passageway (134′) can be much improved when the downstream portion of the flow regulation wall (133′) is not retained by means of pressurized fitting inside the retention portion (111) of the base wall (11).

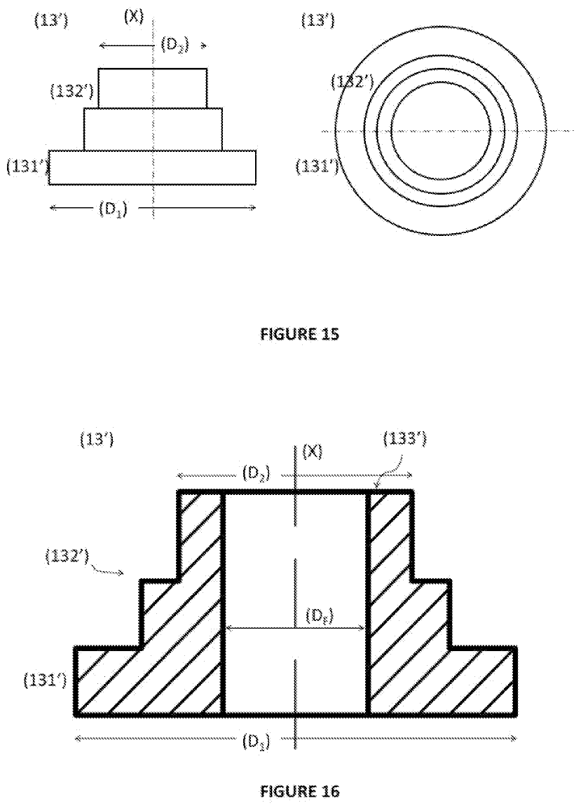

FIGS. 15 and 16 show the construction and main dimensional relations of flow regulation means (13′) of the type of FIG. 12.

The characteristic dimension, D₁, of the upstream portion (131) can be comprised between 5 and 15 mm, whereas the characteristic dimension, D₂, of the downstream edge of the retention portion can be comprised between 2 and 7 mm, preferentially between 3 and 5 mm.

The flow regulation wall (133′) is thus, in practice, adapted so that can be retained only from an interior side thereof, so that can externally confine the flow passageway (134′).

It is advantageous when the wall thickness of the flow regulation wall (133′) can be comprised between 0,5 and 1.5 mm.

It is advantageous when the characteristic dimension of the interior transversal section, D_{F}, of flow passage is smaller than 10 mm, preferentially smaller than 8 mm, and bigger than 1 mm, preferentially bigger than 4 mm.

### Lisbon, Oct. 28, 2020

1. Drinking recipient presenting a base wall and a sidewall that extends therefrom thereby confining a fluid collection volume, and adapted for collecting a beverage discharged through the base wall in a prevailing flow direction opposite the direction of the gravity force,
said base wall presenting a base opening generally extending along the prevailing flow direction and comprising flow regulation means, in particular of single-way valve type, adapted so that only provide flow passage in case of being impinged with an upstream flow pressure bigger than a previously defined value of flow pressure,
characterized
in that the flow regulation means comprise an upstream portion and a downstream portion, whereby the upstream portion presents an exterior transversal section with a characteristic dimension, D₁, bigger than the characteristic dimension, D₂, of exterior transversal section of the downstream portion and is configured so that can sit on an upstream-oriented surface of the base opening, and whereby the downstream portion is configured so that can be retained by means of pressurized fitting inside of the base opening and comprises a flow passage wall that provides a flow passageway that can be actuated elastically.

2. Drinking recipient according to claim 1, characterized
in that the flow regulation means comprise an upstream portion with a flow regulation wall that extends in a generally transversal manner relative to the prevailing flow direction and is adapted so that can provide flow passage through a flow passageway that extends in a non-perimeter portion of the flow regulation wall and is adapted so that can be opened in elastic manner in case of being impinged with an upstream flow pressure bigger than a previously defined value of flow pressure.

3. Drinking recipient according to claim 1, characterized
in that the flow regulation means comprise a downstream portion with a flow regulation wall that extends in a generally parallel manner relative to the prevailing flow direction, and is adapted so that can provide flow passage through a flow passageway that extends a perimeter portion in the downstream edge of the flow regulation wall and is adapted so that can be opened in elastic manner in case of being impinged with an upstream flow pressure bigger than a previously defined value of flow pressure.

4. Drinking recipient according to claim 1, characterized
in that the base opening presents a retention portion that includes tubular surface that extends along the prevailing flow direction, and a seat portion upstream of the retention portion and that includes an upstream-oriented surface that extends in a direction generally transversal relative to the prevailing flow direction, preferentially on an upstream-oriented surface of the base wall,
in that the base opening presents flow constrain means arranged in the entry region into the collection space of the drinking recipient, preferentially aligned with the interior surface of the base wall,
in that the flow regulation means comprise an upstream portion adapted so that can sit in the seating portion, and a downstream portion that presents a bigger extension along the prevailing flow direction than the upstream portion and an exterior transversal section with a characteristic dimension, D₁, for example diameter, adapted so that can be retained by means of pressured fitting in a retention portion of the base wall.

5. Drinking recipient according to claim 1, characterized
in that the flow regulation means are provided so that the upstream portion presents a flow regulation wall arranged in at least one of:
in the proximity of the downstream edge of downstream portion,
in the downstream edge of the downstream portion, between the latter and an upstream portion of flow constraining,
whereby said flow regulation wall preferentially presents a wall thickness that is smaller than the wall thickness of the upstream portion.

6. Drinking recipient according to claim 1, characterized
in that the flow regulation means comprise a flow regulation wall that at least partially confines a flow passageway that corresponds to at least one of:
an extension contained in the flow regulation wall;
an extension along the downstream edge of the downstream portion.

7. Drinking recipient according to claim 1, characterized
in that the base opening comprises flow constraining means that extend upstream with an exterior transversal section of generally cylindrical shape at least partially inside the retention portion, and
in that the flow regulation means comprise a downstream portion with an exterior transversal section adapted so that can be retained by means of pressured fitting along an upstream region thereof, in the retention portion of the base opening, and be further retained with an interior section in a downstream region thereof adapted so that can be retained by means of shape fitting, in an upstream portion of the flow constraining means.

8. Drinking recipient according to claim 1, characterized
in that the flow regulation means comprise an upstream portion and a downstream portion presenting interior transversal sections of similar characteristic dimension, D_{F}, and adapted for flow passage and exterior transversal sections of different characteristic dimension, D₁ and D₂, whereby the upstream portion presents an upstream-oriented surface with a characteristic dimension, D₁, that is preferentially at least twice the characteristic dimension of respective flow passage, D_{F}, so that provides a material perimeter surface of rim type adapted for liquid sealing of said flow passage.

9. Drinking recipient according to claim 1, characterized
in that the flow regulation means are provided as a single piece, preferentially in a single piece with the rest of drinking recipient and in a different synthetic material thereof, and in that the flow regulation means are arranged so that extend at least partially in the interior of the base opening, and
in that the flow regulation means are arranged so that can be removably retained along part of the extension of the downstream portion.

10. Drinking recipient according to claim 1, characterized
in that the flow regulation means present at least one flow passageway with a slot-like format, with at least one of: a linear shape and a curved shape,
whereby the flow regulation means present a resistance to elastic deformation at least on the flow regulation wall, in particular at least in the region confining the flow passageway, adapted so that the latter only opens in case of being impinged with a flow pressure bigger than a previously defined value of flow pressure.

11. Drinking recipient according to claim 1, characterized
in that the flow regulation means present at least one, preferentially at least most part of the following dimensions:
maximum dimension along the prevailing flow direction smaller than 8 mm, preferentially smaller than 6 mm;
maximum direction along the direction transversal to the prevailing flow direction smaller than 12 mm, preferentially smaller than 11 mm;
characteristic dimension, D_{F}, of flow passage section upstream of the flow regulation wall smaller than 10 mm, preferentially smaller than 8 mm, and bigger than 1 mm, preferentially bigger than 4 mm;
characteristic dimension of the flow passageway on the flow regulation wall smaller than 7 mm, preferentially smaller than 4 mm, and bigger than 2 mm.

12. Drinking recipient according to claim 1, characterized
in that the flow regulation means are arranged on a seating portion of the base opening so that results a slot-like perimeter space associated with the upstream portion, and preferentially does not result a slot-like perimeter space associated with the downstream portion.

13. Drinking recipient according to claim 1, characterized
in that the flow regulation means are arranged in a seat portion of the base opening so that the upstream-oriented face of the upstream portion is at least approximately aligned with, or projects itself upstream in an engagement extension above of, with relation to the upstream-oriented surface of said base opening.

14. System for distribution of edible products, such as for example beverages, characterized in that said system includes:
an individual portion of edible substance;
a beverage preparation apparatus comprising:
a beverage discharge disposition adapted so that provides support for operative placement of a drinking recipient, and presents discharge means adapted for beverage discharge along the direction opposite to the direction of the gravity force into the drinking recipient;
a beverage preparation device adapted so that can be actuated between a first and second position, and vice-versa, preferentially by an actuation device, and can thereby collect and eject the individual portion;
and, at least one type of drinking recipient adapted so that can be placed in operative position on the beverage discharge disposition,
characterized
in that the system further includes at least one of:
at least two types of drinking recipient that present at least one of: different format and different configuration of the base wall;
at least two types of flow regulation means that present at least one of: flow regulation wall of different format and flow passageway of different format.

15. Process for production of a drinking recipient including the steps:
providing at least one synthetic material, preferentially two synthetic materials, adapted so that can be mould injected;
providing a mould of a drinking recipient;
injecting the synthetic material, preferentially the two synthetic materials;
obtaining a drinking recipient that includes flow regulation means on the base region thereof,
whereby said flow regulation means are preferentially provided as a piece with elastic behaviour and that can be replaced afterwards.
